(19) United States
(12) Patent Application Publication
(10) Pub. No.: US 2006/0279838 A1
(43) Pub. Date: Dec. 14, 2006

(54) Large telescopic optical system with null alignment optics

(75) Inventors: Yeon-Soo Kim, Daejeon (KR); Hyun-Sook Kim, Daejeon (KR); Hyun-Kyu Kim, Daejeon (KR)

Correspondence Address: Leopold Presser, Scully, Scott, Murphy & Presser, Suite 300, 400 Garden City Plaza, Garden City, NY, 11530, US

(73) Assignee: Agency for Defense Development, Daejeon (KR)

(21) Appl. No.: 11/506,109

(22) Filed: Aug. 17, 2006

Related U.S. Application Data
(63) Continuation-in-part of application No. 11/124,304, filed on May 6, 2005.

(30) Foreign Application Priority Data
Aug. 11, 2004 (KR) 90390/2004

(51) Int. Cl. G02B 23/00

(52) U.S. Cl. 359/399

(57) ABSTRACT

An optical system for monitoring an alignment state of a large telescope comprises a primary mirror and an annular null mirror, which is placed at the outside of a secondary mirror. The optical system functions as a null system, where the wave front of the reflected rays from the null mirror is consistent with the surface shape of the primary mirror in regional band. Since the null system uses a small annular lens on the outside of the secondary mirror, it has the advantages of lightweight and small overall size.

### CROSS-REFERENCE TO RELATED APPLICATION

This application is a continuation-in-part application of Ser. No. 11/124,304, filed on May 6, 2005.

### BACKGROUND OF THE INVENTION

1. Field of the Invention

The present invention relates to a large telescopic optical system with null alignment optics.

2. Description of the Background Art

A large telescopic optical system (so called, ‘beam director’) for distant things observation comprises a primary mirror 10, a secondary mirror 20 and relay mirrors 30a, 30b, 30c, 30d, as shown in FIG. 1. It moves freely in azimuth and elevation direction and its optical path has to be Coude path in order to move around when the target moves. In this beam director, rays emitted from a distant target is incident on a primary mirror 10, reflects from said mirrors, and is finally focused on the focal plane of the beam director. Such a beam director can be used as a long-distance beam transfer system by reversing the direction of the beam. Structural deformation of the beam director can be easily generated by the effects such as aging and thermal deformation, and other causes. Especially, relay mirrors constituting an optical path according to a Coude system; wherein the Coude system is disclosed in FIG. 4.25 on Page 135 of “The design and Construction of Large Optical Telescope” by Pierre Y Bely, Springer-Verlag, New York, 2003, is liable to structurally and/or thermally deform the beam director due to its long optical path. This structural deformation deteriorates the optical performance of the beam director. Therefore, the optical alignment of the beam director must be monitored whenever there are some problems in the alignment state of the beam director.

Conventionally, the alignment state of a beam director has been monitored using the autocollimation method, as shown in FIG. 2. Autocollimation system uses the marginal part of the primary and secondary mirrors. Monitoring rays are incident on the edge part of the secondary mirror. Monitoring rays reflected off the secondary mirror also go to the edge part of the primary mirror and head parallel for the annular reference flat after reflected from the primary mirror. The rays reflected from the annular reference flat go back the exact reverse path. When there is some misalignment between two mirrors, the return beam goes along the different path with the incident beam. As a result thereof, it is possible to monitor the optical alignment. An autocollimation alignment monitoring system needs a larger primary mirror than effective aperture and large annular reference flat for the edge-monitoring beam. Due to the large primary mirror and annul reference flat, a large mechanical structure is required and it is not easy to be assembled as well. Also, the cost of the system might be high.

### SUMMARY OF THE INVENTION

Therefore, an object of the present invention is to provide an improved monitoring system for the optical alignment of a beam director.

Another object of the present invention is to reduce the size of a beam director and its manufacturing cost by using a new alignment monitoring system without a large annular flat reference mirror.

To achieve these and other advantages and in accordance with the purpose of the present invention, as embodied and broadly described herein, there is provided a large telescopic optical system with null alignment optics comprising: a primary mirror; a secondary mirror facing the primary mirror; an annular null mirror at the outside of the secondary mirror, and a detecting unit measuring an optical alignment state of the large telescopic optical system by way of rays reflected from the annular null mirror.

The detecting unit comprises a beam splitter dividing rays reflected from the annular null mirror, a focusing lens collecting rays divided by the beam splitter, and a position sensitive detector sensing the displacement of a spot image via the focusing lens.

The annular null mirror and the secondary mirror are held on the same mount so that both the mirrors can move together with each other.

When parallel rays incident on the annular null mirror are reflected and then bound for the inner part of the primary mirror, rays reflected from the primary mirror go back the exact reverse path to the incident point at the annular null mirror.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a laser beam director;

FIG. 2 is a schematic view of autocollimation alignment optics;

FIG. 3 is a schematic view of null alignment optics in accordance with the present invention;

FIG. 4 shows optical path difference of null alignment optics in accordance with the present invention;

FIG. 5 shows displacement of spot image generated by tilt angle 0.1 deg. of annular mirror; and

FIG. 6 shows MTF performance of null optics for tilt angle 0.1 deg. of annular mirror.

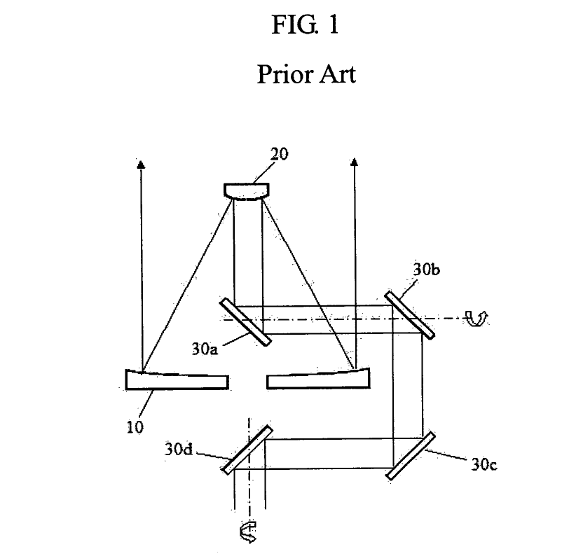

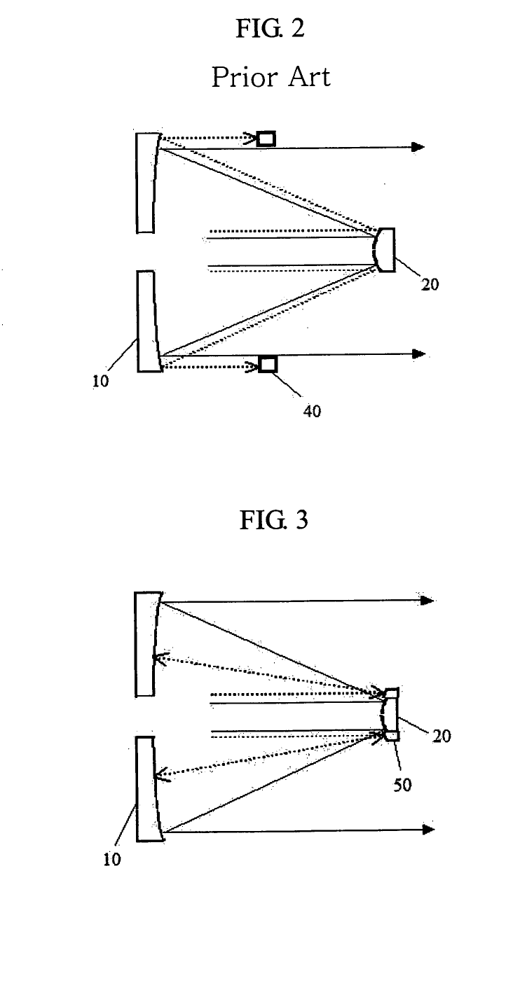

### DETAILED DESCRIPTION OF THE PREFERRED EMBODIMENTS

Reference will now be made in detail to the preferred embodiments of the present invention, examples of which are illustrated in the accompanying drawings.

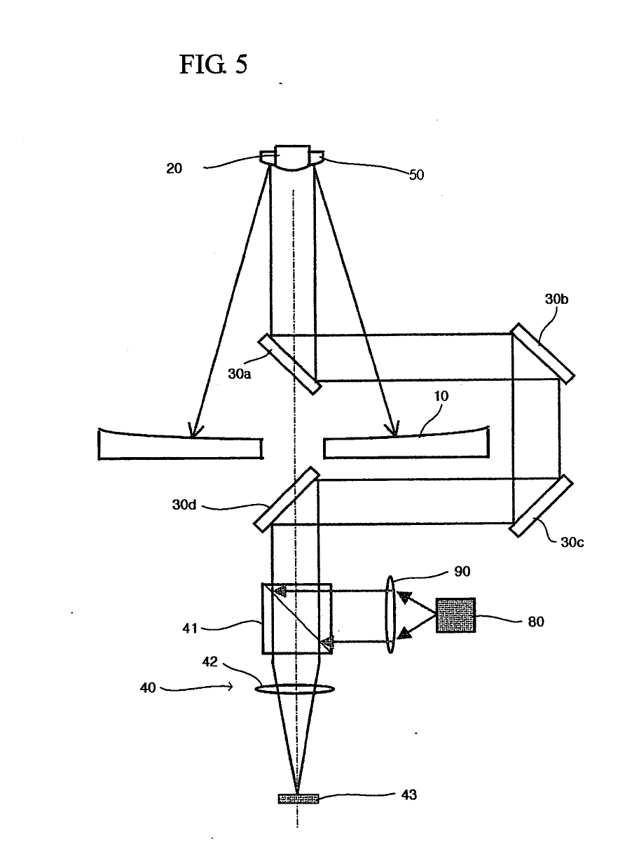

Referring to FIG. 3 and FIG. 5, a large telescopic optical system with null alignment optics according to an embodiment of the invention comprises a primary mirror 10, a secondary mirror 20, an annular null mirror 50, a detecting unit 40, a plurality of relay mirrors 30a, 30b, 30c, 30d, a light source 80, and collimating lens 90.

The primary mirror 10 faces the secondary mirror 20 at the outside of which the annular null mirror 50 is positioned.

The detecting unit 40 comprises a beam splitter 41, a focusing lens 42, and a position sensitive detector 43.

The beam splitter 41 reflects the ray of light emitted from the light source 80 and passes the light from the relay mirror 30d to the focusing lens 42.

The focusing lens 42 focuses the light from the beam splitter 41 to the position sensitive detector 43 so that the position sensitive detector 43 detects the information of the optical alignment state of the large telescopic optical system.

The position sensitive detector 43 detects the information of the optical alignment state by sensing the displacement of a spot focused by the focusing lens 42.

The plurality of relay mirrors 30a, 30b, 30c and 30d forms a path between the beam splitter 41 and the secondary mirror 20. One of the relay mirrors 30a, 30b, 30c and 30d moves in azimuth direction and elevation direction based on the information detected by the position sensitive detector 43.

The collimating lens 90 collimates the light from the light source 80 to direct the collimated light to the beam splitter 41. And collimated light is reflected by the beam splitter 41 to the plurality of mirrors 30a, 30b, 30c and 30d, which direct the light toward the secondary mirror 20 and the annular null mirror 50.

In accordance with the present invention, as shown in FIG. 3 and FIG. 5, an annular null mirror 50 is integrally or separately included on the outside of the secondary mirror.

The annular null mirror 50 and a primary mirror 10 constitute a null alignment optics, which monitors the optical alignment of a beam director. The null alignment optics functions as a null system, where the wave front of the reflected rays from the null mirror is consistent with the surface shape of the primary mirror 10 in regional band. In the optical path of the beam director with the null system, rays divided by a beam splitter is focused via a focusing lens on a position sensitive detector. The state of the alignment can be checked by measuring the degree of the deviation of the spot image focused on the position sensitive detector 43. Since such a null system uses a small null lens on the outside of the secondary mirror 20, it has the advantages of lightweight and small overall size.

Rays incident on the secondary mirror 20 reflects from the secondary mirror 20 and the primary mirror 10 and proceeds toward the distant target, whereas monitoring parallel rays incident on the annular mirror are reflected and then bound for the inner part of the primary mirror. Monitoring rays reflected from the primary mirror go back the exact reverse path and comprise null system.

The null alignment optics according to the present invention is sensitive to the off-axis deviation, such as tilt and decenter of the components of a beam detector, and on the contrary, has very low residual aberration sensitivity to the misalignment. Moreover, if the focal point with respect to a focal lens is adjustably varied, the null alignment optics can measure very small amount of the off-axis misalignment.

### EMBODIMENT

While the present invention will be illustratively described, it should be understood that the embodiments are offered by way of example only. The present invention is not limited to the embodiments, but rather should be construed broadly within its spirit and scope as defined in the appended claims. Therefore all changes and modifications that fall within the metes and bounds of the claims, or equivalence of such metes and bounds are therefore intended to be embraced by the appended claims.

1. Optical Design

First, a beam director was designed to be composed of both a primary mirror 10 and a secondary mirror 20. Table 1 shows the data of the designed two-mirror telescope.

TABLE 1
Design data of two-mirror telescope

(unit: mm)

| | Radius of | | Conic | Height of |
|---|---|---|---|---|
| No. | curvature | Thickness | constant | marginal ray |
| Infinite | ∞ | 0 | | |
| 1 | 182.88 | −365.112 | −1.009102 | 27.5 |
| 2 | 912.69 | 1,000,000. | −1 | 137.5 |

The primary mirror 10 with parabolic surface has the effective diameter of 275 mm with the obscuration of 81.0 mm at the center of the aperture. The secondary mirror 20 has the hyberbolic surface and its diameter is 55.0 mm. Its magnification is about 6 and the half field-of-view is above 1 mrad, which can guarantee the diffraction limited optical performance. Incident parallel beam on the secondary mirror 20 is expanded by the primary mirror 10 and focused on the target 1 km away.

Then, null optics for checking optical alignment was designed. The null optics is composed of both primary mirror 10 and an aspheric annular mirror 50 that is in the same place as the secondary mirror 20. The null optics was designed to be a null system, so that the wavefront of the reflected rays from the null mirror 50 may be consistent with the surface shape of the primary mirror 10 in regional band. Monitoring rays reflected from the primary mirror 10 go back the exact reverse path to the annular null mirror 10. The designed data of null optics are shown in the Table 2.

TABLE 2
Design data of the null optics

(unit: mm)

| | | | | Height of ray | |
|---|---|---|---|---|---|
| | Radius of | | Conic | Inner | Outer |
| No. | curvature | Thickness | constant | ray | ray |
| Infinite | ∞ | 0 | | | |
| 1 | 1095.15 | −365.112 | −7.653574 | 28.5 | 33.5 |
| 2 | 912.69 | 365.112 | −1.0 | 47.4 | 55.7 |
| 3 | 1095.15 | 0 | −7.653574 | 28.5 | 33.5 |
| Infinite | ∞ | | | | |

Since the annular null mirror 50 is placed on the same mount, which holds the secondary mirror 20, the monitoring rays only in the height range of 28.5 mm to 33.5 mm at the secondary mirror plane are used for alignment inspection of beam director.

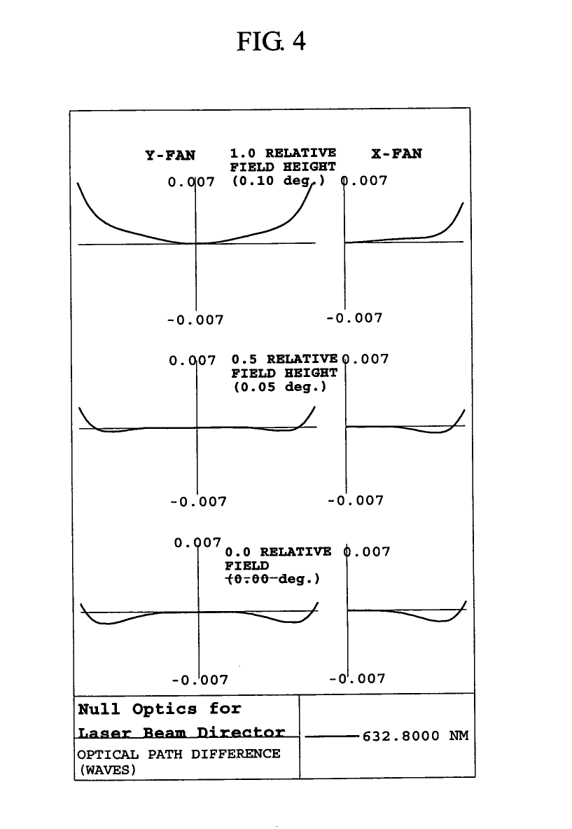

Optical path difference (OPD) over the full diameter of annular null mirror 50 is shown in FIG. 4. The valid OPD values for the monitoring rays are just data that ranges from 0.85 to 1.0 ratio of the annular diameter. OPD is less than 0.007λ at the field of view of 0.1 degree. Here λ is 0.633 μm.

2. Performance Test

The original purpose of the null mirror optics is to check the optical alignment of the beam director in real time. Therefore, the null mirror system itself must be sensitive, in some way, to the tilt and decenter of the components. But, the null optics must have very low residual aberration sensitivity to the misalignment.

Table 3 shows the optical sensitivity of the null optics for the tilt and decenter errors about the y-axis of the primary mirror 10 for convenience and the despace error of the annular null mirror 50 with respect to the primary mirror 10. Sensitivity is given as the change of the Zernike coefficients with respect to the small displacements of the annular mirror. The Zernike coefficients were calculated over the actual annular aperture.

TABLE 3
Sensitivity analysis and wave front errors

(@ 632.8 nm)

| Induced | sensitivity (λ/mrad, λ/mm) | | | | wave front errors (λ) | | | |
|---|---|---|---|---|---|---|---|---|
| errors | C4 | C5 | C9 | C13 | C4 | C5 | C9 | C13 |
| Tilt | 0.001 | −0.004 | 0.005 | 0.000 | 0.000 | 0.000 | 0.005 | 0.000 |
| (mrad) | | | | | | | | |
| De- | 0.000 | 0.000 | −0.038 | 0.000 | 0.000 | 0.000 | −0.004 | 0.000 |
| center | | | | | | | | |
| (mm) | | | | | | | | |

C4: Astigmatism with axis at 45°
C5: Defocus
C9: Third-order coma along y-axis
C13: Third-order spherical aberration

As shown in the Table 3, the null mirror system has very low aberration dependency or sensitivity for the tilt and decenter errors of the annular mirror 50. So, the null mirror system would not experience the large degradation in optical performance with respect to the alignment error of mirrors. This fact gives the null optics the merit to be used as an alignment monitoring apparatus.

3. Measurement of Alignment Errors

The off-axis alignment error of a beam director was measured by using the null optics in accordance with the present invention.

The annular mirror 50 is placed on the same mount which holds the secondary mirror 20, so the annular mirror 50 experiences the same tilt and decenter as the secondary mirror 20. When the secondary mirror 20 is tilted or decentered, the collimated rays incident on the primary mirror axis becomes off-axis rays with respect to the annular null mirror 50. The output rays through the null mirror system become off-axis rays. If the output rays are focused using the focusing lens 42, we can get an off-axis spot image. When we measure the degree of the deviation from the center, we can calculate the displacement of the secondary mirror 20.

For example, alignment error is made that the secondary mirror 20 is tilted by 0.1°. For convenience, it is assumed that the collimated rays are incident through the relay mirror on the annular null mirror 50. The rays reflected from the annular null mirror 50 are reflected from the primary mirror 10 and return to the initially incident plane through the annular null mirror 50 and relay mirror 30a, 30b, 30c and 30d. If the ideal lens is placed in that plane, we can measure the displacement that is generated by alignment errors.

Tilted secondary mirror, (that is, tiled annular mirror) makes the slope of the output ray from the null optics. In case that the annular null mirror 50 is tilted by 0.1°, the slope of the output rays is four times as much as tilt angle of the annular null mirror 50. In case the secondary mirror 20 is decentered, the null optics can measure the amount of misalignment through the same method as well. Rays passing through a focusing lens 42 experiences off-axis deviation of spot image. Assuming that the focal length of the focusing lens 42 is 300 mm, the off-axis displacement by tilt is about 2.1 mm. If the focal length of the focusing lens 42 and the position sensitive detector 43 are optimized, the misalignment of a beam director can be more precisely measured.

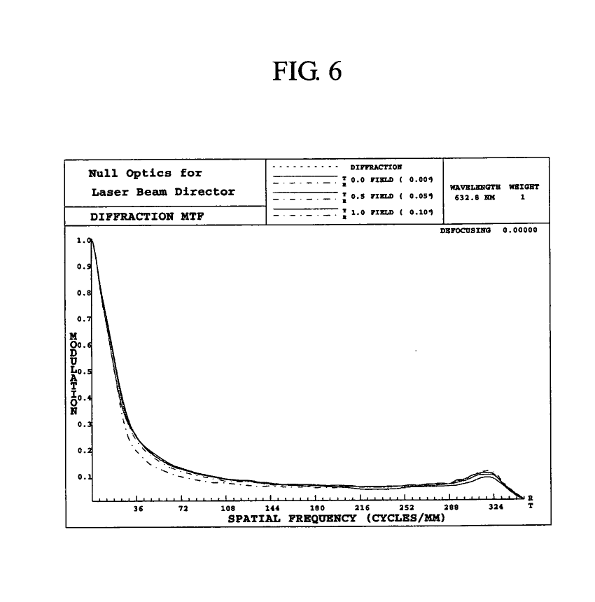

FIG. 6 shows Modulation Transfer Function (MTF) of the null optics in case that the annular null mirror 50 is tilted by 0.1°. The null optics does not show any prominent changes in MTF with respect to the diffraction limited MTF and retains the high quality of image. Therefore, the output rays from the null optics are focused with clear image on the focal plane, which enhances a precise measurement of the misalignment of a beam director.

As described above, since the null alignment optics according to the present invention uses a small annular null mirror 50 at the outside of a secondary mirror 20, it can reduce the weight and size of the beam director having the same. Further, the null mirror system shows very small aberration for the misalignment of the mirrors, but it shows high sensitivity to the off-axis misalignment of a beam director. Therefore this null mirror system can be used successfully as an alignment monitoring apparatus of the beam director.

What is claimed is:

1. A large telescopic optical system with null alignment optics comprising:
a primary mirror;
a secondary mirror facing the primary mirror;
an annular null mirror at the outside of the secondary mirror; and
a detecting unit measuring an optical alignment state of the large telescopic optical system by way of rays reflected from the annular null mirror.

2. The large telescopic optical system of claim 1, wherein the detecting unit comprises a position sensitive detector sensing the displacement of a spot and outputting a signal indicating the optical alignment state, and a focusing lens focusing the ray to the position sensitive detector.

3. The large telescopic optical system of claim 1, wherein the annular null mirror and the secondary mirror is held on the same mount.

4. The large telescopic optical system of claim 1, when parallel rays incident on the annular null mirror are reflected and then bound for the inner part of the primary mirror, rays reflected from the primary mirror go back the exact reverse path to the incident point at the annular null mirror.

5. The large telescopic optical system of claim 2, comprising:
a light source; and
a plurality of relay mirrors directing the light from the light source to the secondary mirror and directing the light reflected from the annular null mirror to the focusing lens; wherein the detecting unit comprises a beam splitter reflecting the light from the light source to the plurality of relay mirrors and passing the light from the plurality of relay mirrors to the focusing lens.
